(19) United States
(12) Patent Application Publication
(10) Pub. No.: US 2004/0093496 A1
(43) Pub. Date: May 13, 2004

(54) Method and apparatus to secure online transactions on the internet

(76) Inventor: Vincent Cedric Colnot, Milpitas, CA (US)

Correspondence Address: OHVA, INC, 803 KEVENAIRE DR., MILPITAS, CA, 95035, US

(21) Appl. No.: 10/696,650

(22) Filed: Oct. 30, 2003

Related U.S. Application Data
(60) Provisional application No. 60/423,399, filed on Nov. 4, 2002.
(60) Provisional application No. 60/423,448, filed on Nov. 4, 2002.

(51) Int. Cl. H04L 9/00

(52) U.S. Cl. 713/168

(57) ABSTRACT

A method and apparatus to secure online transactions on the Internet comprising a smart card transmitting an identification sequence to a PC in the form of a modulated signal, a card reader plugged into the microphone input of the PC sound card, and a PC applet demodulating the identification sequence. The card reader is characterized by the absence of processing means.

### CROSS REFERENCE TO RELATED APPLICATIONS

This application claims the benefit of the following filing date of the provisional patents Nos. 60/423,399, and 60/423,448 filed on Nov. 4, 2002.

### TECHNICAL FIELD

The present invention relates to a method to secure online transactions on the Internet, and an apparatus implementing the method.

### BACKGROUND OF THE INVENTION

Integrated circuit cards, commonly referred to as smart cards, are widely used in stores to secure electronic payments.

Smart cards have not been adopted by the online market, although they provide the best security to conduct electronic commerce. The main reasons are the high cost of the card reader and the complexity of the system for most people. Not only a card but also a reader must be provided to the millions of potential end-users who comprise this market base.

The object of the present invention is to provide an inexpensive and easy to use smart card system to secure online transactions on the Internet. The smart card authenticates the user when managing bank accounts, making payments, or eventually voting online, for example.

### SUMMARY OF THE INVENTION

The above object has been achieved by a smart card transmitting an identification sequence to a PC by means of a card reader plugged into the microphone input of the PC sound card. The reader is actually a simple and inexpensive connector without processing means. The smart card remains compliant with the ISO 7816 standards and can be used in the existing card readers.

### BRIEF DESCRIPTION OF THE DRAWINGS

FIG. 1 illustrates the method according to the present invention.

FIG. 2A is a schematic of the reader powered by the microphone input

FIG. 2B is a schematic of the reader powered by a battery cell.

FIG. 2C is a schematic of the reader with a microphone capsule.

### DETAILED DESCRIPTION

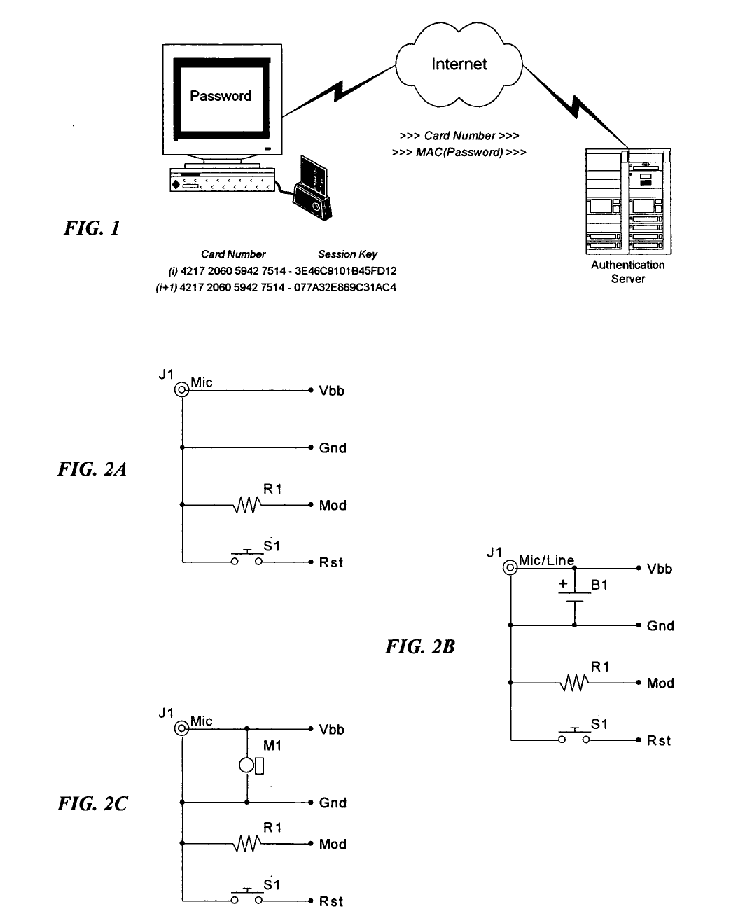

The method, as detailed in FIG. 1, carries out the user authentication on the Internet. The apparatus comprises a smart card with a modulation output, a card reader plugged into the microphone input, and a PC applet. The user inserts his card in the reader and enters his password on the PC keyboard.

When activated in the card reader, the smart card transmits an identification sequence to the PC in the form of a modulated signal, which is demodulated by the PC applet. The identification sequence comprises an 8-byte card number and an 8-byte random number valid only once. The card number is unique and identifies the card issuer, application version and user account. The random number is a session key (Ki) which is a function of the previous one (Ki-1) emitted by the card such as: Ki=G(Ki-1), G is a one-way function also known by the authentication server.

The session key (Ki) is used by the PC applet to generate a message authentication code (MAC) of the password entered by the user, using the DES algorithm for instance. This first MAC is transmitted to the authentication server along with the card number, allowing the server to retrieve the previous session key (Ki-1) and the password stored in the authentication server database.

The authentication server deduces from (Ki-1) the session key used by the card, and generates a second MAC of the password stored in the database. The authentication is valid only if the first and second MAC are identical, which means the PC and the authentication server have used the same session key (Ki) to generate a MAC of the same password. If this is the case, the authentication server replaces (Ki-1) by (Ki) in the database. The session key (Ki) cannot be reused, even though the session key (Ki) has not been transmitted to the authentication server.

In a preferred embodiment, the smart card comprises a secure memory device with a modulation output (Mod) using a FSK (Frequency Shift Keying) modulation, for instance. The modulation frequency is in the range of 0 Hz to 20 kHz compatible with the sound card capabilities. The modulation output (Mod) is activated only when the device is powered by the secondary power pad (Vbb) and the reset input (Rst) is pulled down.

When the smart card is used in a standard ISO 7816 reader, the secure memory device is powered by the main power pad (Vcc) disabling the modulation output (Mod). The ISO reader provides the clock (Scl) and communicates with the device using a bidirectional terminal (Sda).

The secure memory device is connected to the ISO contacts as followed:

C1 = Vcc
C2 = Rst
C3 = Scl
C4 = Vbb
C5 = Gnd
C6 = Mod
C7 = Sda
C8 = Gnd

The modulated signal is transmitted to the PC via a card reader, as detailed in FIG. 2A, plugged into the microphone input (Mic). Only four ISO contacts (C2, C6, C4, and C8) are required to activate the smart card.

The PC sound cards provides a +3V to +5V DC voltage on the microphone input which is sufficient to power (Vbb) the smart card. The resistor R1 adapts the level of the modulated signal to the microphone input. When pressed, the switch S1 pulls down the reset input (Rst) activating the modulation output (Mod).

The reader could be further integrated into the PC unit or display.

A first variant of the card reader, as detailed in FIG. 2B, comprises a battery cell (B1) powering the card. This reader can be alternatively plugged into the line input (Line) of the PC sound card.

A second variant of the card reader, as detailed in FIG. 2C, comprises a microphone capsule (M1) and can replace the PC microphone.

1: A method and apparatus to secure online transactions on the Internet comprising:
a smart card transmitting an identification sequence to a PC in the form of a modulated signal,
a card reader plugged into the microphone input of the PC sound card,
a PC applet demodulating the identification sequence, and characterized by the absence of processing means within the card reader.

2: A method as in claim 1, wherein the identification sequence comprises at least a unique card number and a random number valid only once.

3: A method as in claim 2, wherein the random number is a session key (Ki) which is not transmitted to the authentication server.

4: A method as in claim 3, wherein the session key (Ki) is a function of the previous one (Ki-1) emitted by the card such as: Ki=G(Ki-1), G is a one-way function also known by the authentication server.

5: A method as in claim 4, wherein the session key (Ki) is used by the PC applet to generate a message authentication code (MAC) of the password entered by the user; said first MAC is transmitted to the authentication server along with the card number.

6: A method as in claim 5, wherein the authentication server generates a second MAC of the password stored in the authentication server database, using a session key deduced from the previous one (Ki-1) also stored in the database.

7: A method as in claim 6, wherein the authentication is valid only if said first and second MAC are identical; if this is the case, the authentication server replaces (Ki-1) by (Ki) in the database and (Ki) cannot be reused.

8: An apparatus as in claim 1, wherein the smart card is powered by the voltage provided by the microphone input of the PC sound card.

9: An apparatus as in claim 8, wherein the smart card transmits the modulated signal when the switch of the card reader is pressed by the user.

10: An apparatus as in claim 9, wherein the smart card transmits the modulated signal to the microphone input through the ISO contact C6.

11: An apparatus as in claim 10, wherein the smart card transmits the modulated signal when the ISO contact C2 is pulled down.

12: An apparatus as in claim 11, wherein the smart card is powered through the ISO contacts C4 and C8.

13: An apparatus as in claim 1, wherein the card reader further comprises a battery cell powering the card; said reader is alternatively plugged into the line input of the PC sound card.

14: An apparatus as in claim 1, wherein the card reader further comprises a microphone capsule.

15: An apparatus as in claim 1, wherein the card reader is further integrated into the PC unit or display.
